(19) United States
(12) Patent Application Publication
(10) Pub. No.: US 2015/0262111 A1
(43) Pub. Date: Sep. 17, 2015

(54) APPARATUS AND METHOD FOR EFFICIENT TASK ALLOCATION IN CROWDSOURCING

(71) Applicant: NANYANG TECHNOLOGICAL UNIVERSITY, Singapore (SG)

(72) Inventors: Han YU, Singapore (SG); Chunyan MIAO, Singapore (SG); Zhiqi SHEN, Singapore (SG)

(73) Assignee: NANYANG TECHNOLOGICAL UNIVERSITY, Singapore (SG)

(21) Appl. No.: 14/656,009

(22) Filed: Mar. 12, 2015

Related U.S. Application Data
(60) Provisional application No. 61/951,785, filed on Mar. 12, 2014.

(51) Int. Cl. G06Q 10/06; G06Q 50/00

(52) U.S. Cl. CPC G06Q 10/063112; G06Q 10/063118; G06Q 50/01

(57) ABSTRACT

A method and apparatus are proposed for allocating a plurality of human intelligence tasks (HIT) to corresponding human workers. An optimization problem is formulated which incorporates the objectives of reducing the time taken for the HITs to be completed, and of improving the quality of HIT results. The method and apparatus are able to provide solutions to the optimization problem in polynomial time, and to provide theoretical guarantees on the optimality of the solution. The optimization problem is formulated using a measure of a target workload for each worker and a measure of each worker's current situation.

### FIELD OF THE INVENTION

The invention relates to automatic methods and systems for allocating human intelligence tasks (HITs) to a plurality of workers.

### BACKGROUND OF THE INVENTION

Crowdsourcing systems are a unique type of collaborative computing systems where human beings act as workers to perform human intelligence tasks (HITs) in exchange of monetary or other forms of payoffs. In existing crowdsourcing systems (e.g., Amazon's Mechanical Turk, 99designs, and Mob4hire), the common task assignment mechanism is to broadcast the tasks and wait for workers to choose them (the worker-pull model). As human beings from diverse backgrounds and with potentially conflicting self interests, workers may misbehave when performing HITs. Therefore, the wellbeing of a crowdsourcing system is faced with two major challenges:
1) To reduce the time taken to complete HITs, HIT allocation to a large number of workers should be automated; and
2) To ensure the quality of the HIT results, requesters should be able to provide feedback on the quality of the results they receive and use the feedback to reward trustworthy workers and punish untrustworthy ones.

Efforts have been made to address the first challenge through automating the process of task allocation using a system-push model. For example, in U.S. Pat. No. 8,099,311, a method and system for assigning tasks to individual workers in a workforce has been proposed. It uses their personal characteristics for initial classification of their likely behavior pattern using a neural network based method. Then, it incrementally refines the neural network with their performance with the tasks assigned to them as time goes by. In US 20110282793 A1, a contextual task assignment Confidential Document broker has been proposed. However, in this patent application, the worker profile does not take into account each individual worker's situational information including his/her current workload or their average task processing capacity.

To address the second challenge, the most widely used approach is reputation management. The feedback ratings on the past performance of a worker are used to compute a reputation score which, in turn, is used by the requesters to determine whether to allow the worker to perform the HITs they propose in the future. Many methods for computing the reputation of an entity have been proposed. For example, in U.S. Pat. No. 8,015,484, a method for providing a measure of trust for each participant in a network and automatically computing it has been disclosed. Apart from past performance information, social networking information has been used to compute reputation as exemplified in U.S. Pat. No. 8,010,460. A system for securely disseminating reputation reports on-demand has been disclosed in U.S. Pat. No. 8,117,106.

The abovementioned two challenges represent conflicting system objectives. To reduce the time taken to complete HITs, HITs should be distributed as evenly as possible to a large number of workers to take advantage of mass collaboration. However, to ensure the quality of HIT results, HITs should be allocated as often as possible to workers with high reputation scores who tend to be a minority in a crowdsourcing system. Reputation-based prior art methods over-assign HITs to highly reputable workers, while workload-based prior art methods do not provide sufficient guarantees on the quality of HIT results.

It is an object of the invention to provide an apparatus to address both of the abovementioned challenges simultaneously.

### SUMMARY OF THE INVENTION

In general terms, the present invention proposes a method and apparatus for allocating a plurality of human intelligence tasks (HIT) to corresponding human workers, by formulating an optimization problem which incorporates both the objectives of reducing the time taken for the HITs to be completed, and of improving the quality of HIT results. The method and apparatus are able to provide solutions to the optimization problem in polynomial time, and to provide theoretical guarantees on the optimality of the solution. The optimization problem is formulated using a measure of a target workload for each worker and a measure of each worker's current situation.

The invention may be expressed in terms of a method for performance by a computer, or a computer system programmed to perform the method, or as a computer program product such as a tangible data storage device (e.g. a CD) storing computer program instructions operative when run by a computer processor to cause the computer processor to perform the method.

### BRIEF DESCRIPTION OF THE DRAWINGS

FIG. 1 is a diagram of a computing environment including a situation-aware task allocation apparatus which is an embodiment of the invention.

FIG. 2 is a block diagram of the situation-aware task allocation apparatus 102 which is an embodiment of the invention.

FIG. 3 is a flowchart of the steps performed by the situation-aware take allocation apparatus of FIG. 2.

### DETAILED DESCRIPTION OF THE PREFERRED EMBODIMENT

FIG. 1 is a diagram of a computing environment including a situation-aware task allocation apparatus 102 which is an embodiment of the invention. The environment includes a requester 103, the situation-aware task allocation apparatus 102 which is an embodiment of the invention, and a plurality of workers 104. The requester 103, the situation-aware task allocation apparatus 102 and a respective communication device (not shown) of each of the plurality of workers 104, are configured to communicate over via a communication network provided by a crowdsourcing system 101.

The requester 103 submits a project which includes a plurality of tasks to the crowdsourcing system 101 using a computing device, a mobile phone, a personal digital assistant, a telephone, or the like. The requester 103 is anyone who submits tasks to the crowdsourcing system 101 and may be, for example, a person, someone acting on behalf of an entity, or a group of people. In actual implementation of the invention, there may be a plurality of requesters 103, each submitting respective project(s) to the crowdsourcing system, but for ease of understanding only a single requester 103 is shown, and the explanation below shows how a project submitted by that requester 103 is processed.

The crowdsourcing system 101 forwards the tasks to the task allocation apparatus 102. The situation-aware task allocation apparatus 102 is configured to receive tasks from the crowdsourcing system 101. The tasks include at least one task attribute that identifies the type the tasks belong to and an associated price the requester is willing to pay for its successful completion.

The situation-aware task allocation apparatus 102 may comprise a computer system including at least one computer readable medium, a processor, and/or logic. For example, the situation-aware task allocation apparatus 102 may comprise a processor configured to execute computing instructions stored in the computer readable medium. These instructions may be embodied in software. In some embodiments, the computer readable medium comprises an IC memory chip, such as, for example, static random access memory (SRAM), dynamic random access memory (DRAM), synchronized dynamic random access memory (SDRAM), non-volatile random access memory (NVRAM), and read-only memory (ROM), such as erasable programmable read only memory (EPROM), electrically erasable programmable read only memory (EEPROM), solid state drive (SDD) and flash memory. Alternatively, the situation-aware task allocation apparatus 102 may comprise one or more chips with logic circuitry, such as, for example, a processor, a microprocessor, a microcontroller, an application specific integrated circuit (ASIC), a field programmable gate array (FPGA), a programmable logic device (PLD), a complex programmable logic device (CPLD), or other logic device.

Upon receiving the tasks, the situation-aware task allocation apparatus 102 is configured to access a respective situational profile for each of the plurality of workers 104 and determine which one(s) of the plurality of workers to allocate the tasks to and how many tasks should be allocated to each one of them.

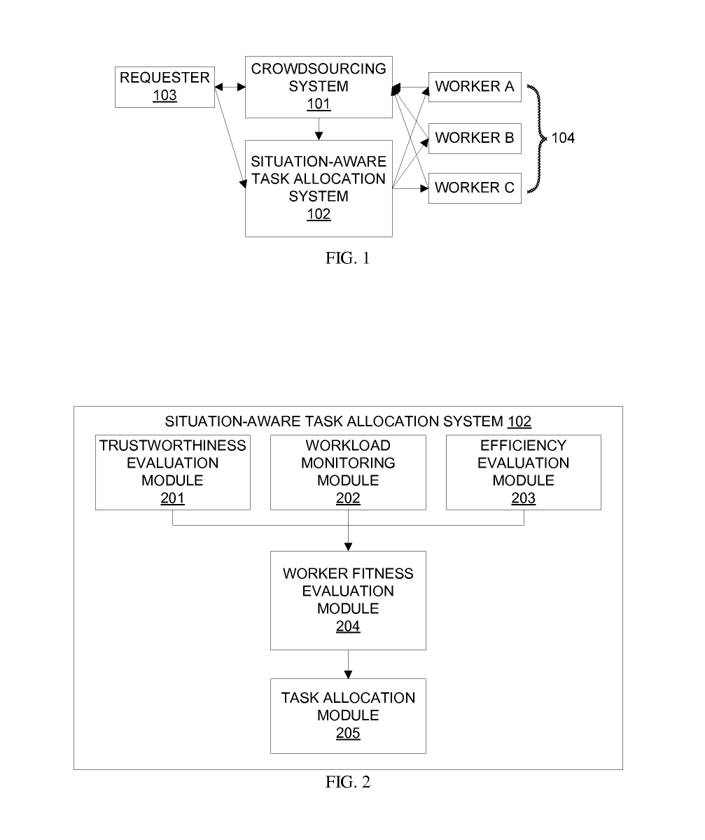

A worker is a person who may be able to provide solutions to tasks. The situational profile may include information about the worker's trustworthiness, current workload and efficiency. The situational profiles are discussed further below in connection with FIG. 2.

Upon allocating tasks to the plurality of workers, the situation-aware task allocation apparatus 102 sends messages to the workers 104 via the communication network provided by the crowdsourcing system 101 using a computing device, a mobile phone, a telephone, a personal digital assistant, or the like. The workers may provide solutions to the tasks allocated to them. Feedback is collected by the situation-aware task allocation apparatus 102 based at least partly on the requester's evaluation of the quality of the solutions. The arrow in FIG. 1 from the requester 103 to the task allocation apparatus 102 indicates the feedback from the requester 103 on the quality, timelines and other possible measures of the results produced by each worker.

FIG. 2 is a block diagram of the situation-aware task allocation apparatus 102. The situation-aware task allocation apparatus 102 includes a trustworthiness evaluation module 201, a workload monitoring module 202, an efficiency evaluation module 203, a worker fitness evaluation module 204, and a task allocation module 205. The modules may be implemented in the situation-aware task allocation apparatus 102 as software and/or hardware.

The trustworthiness evaluation module 201 is configured to evaluate the trustworthiness of each individual worker. Feedback from the requesters about the quality of the solutions to the tasks is collected. Feedback can be in the form of, for example, discrete numerical ratings, decimal numerical ratings, ordinal textual descriptions of quality, and/or textual comments. The trustworthiness score of a worker is calculated based at least on the feedback from the requesters. The methods used to derive the trustworthiness score can be, for example, probabilistic, statistical, cognitive, logical and/or social relationship based. The trustworthiness score is a numerical number which is scale and metric independent, bounded, and continuous.

The workload monitoring module 202 is configured to evaluate the current workload of each individual worker in real time. Workload related information includes the number of tasks currently assigned to a worker, the price of the tasks currently assigned to a worker, and the estimated effort level required to complete each task currently assigned to a worker. The workload of a worker is a numerical number which is scale and metric independent, and continuous.

The efficiency evaluation module 203 is configured to evaluate the long term efficiency of each individual worker. Workers can estimate and report their own efficiency to the efficiency evaluation module 203 when they first join the crowdsourcing system. The evaluation of the workers' efficiency is based on their past behavior in performing the tasks. For example, data may be collected based on whether a selected worker accepts allocated task(s) of specific type(s), the elapsed amount of time for a selected worker to accept the allocated task(s) of specific type(s), whether a selected worker completes the allocated task(s) of specific type(s), the elapsed amount of time for a selected worker to complete the allocated task(s) of specific type(s). The efficiency of a worker is a numerical number which is scale and metric independent, and continuous.

The worker fitness evaluation module 204 is configured to evaluate each worker's current fitness for receiving more tasks. The worker fitness evaluation module 204 calculates a target workload for each worker based on the worker's trustworthiness information provided by the trustworthiness evaluation module 201 and efficiency information provided by the efficiency evaluation module 203. In one embodiment, the formula for calculating the target workload for a worker w can be:

q^{target}(w)=└τ^{max}(w)·V+μ^{max}(w)┘ (1)

where τ^{max}(w) and μ^{max}(w) are respectively the maximum trustworthiness score and maximum efficiency achieved by a worker w over a given period of observation; V is a control parameter which can be varied to enable the system administrator of the situation-aware task allocation apparatus 102 to select how emphasis the apparatus places respectively on the expected quality of work and on the delay. As apparent to those skilled in the art, the method for calculating a worker's target workload should ensure that the higher the worker's trustworthiness and efficiency, the higher the target workload should be and vice versa.

The worker fitness evaluation module 204 then calculates the fitness score of each individual worker based on the worker's current workload information provided by the workload monitoring module 202 and the worker's target workload. The fitness score indicates how appropriate it is to assign new work to the worker at time t. In one embodiment, the formula for calculating the current fitness score of a worker w can be:

f_{w}(t)=q^{target}(w)−q_{w}(t)−p(x)·V·(1−τ_{w}(t)) (2)

where q_{w}(t) is the current workload for the worker; p(x) is the payoff for successfully completing task x; and τ_{w}(t) is the current trustworthiness score of w. The purpose of the final term is that bad workers are not given jobs of high importance. Such workers will have a high (1−τ_{w}(t)), so the final term will reduce the fitness score very significantly. As apparent to those skilled in the art, the method for calculating a worker's fitness score should ensure that the higher the worker's target workload is and the lower the worker's current workload is, the higher the worker's fitness score should be and vice versa. Once the fitness scores for all workers are calculated, the workers are ranked in descending order of their fitness scores to form a worker fitness ranking list stored in the worker fitness evaluation module.

The task allocation module 205 is configured to allocate tasks to workers based on their current fitness scores provided by the worker fitness evaluation module 204.

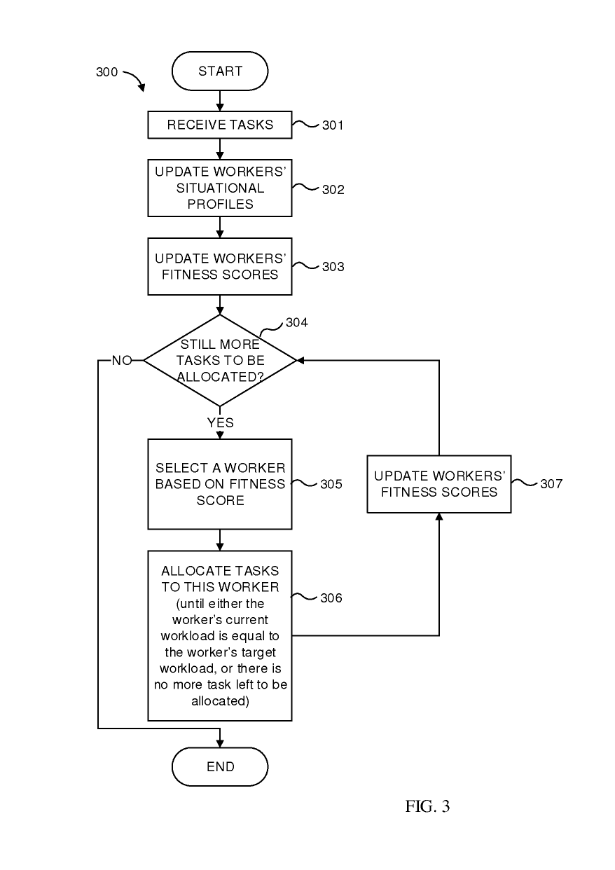

FIG. 3 is a flowchart of a method 300 for the situation-aware allocation of tasks to workers in a crowdsourcing system according to various embodiments. The method 300 may be performed by the situation-aware task allocation apparatus 102.

In step 301, a set of tasks from one or more requesters is received from the crowdsourcing system. The step 301 may be performed by the task allocation module 205. The tasks may be held in a temporary buffer in the task allocation module 205 before being allocated.

In step 302, workers' situational profiles are updated. The step 302 includes incorporating new feedback into trustworthiness evaluations, monitoring workers' workload in real time, and updating workers' efficiency. The step 302 may be performed by the trustworthiness evaluation module 201, the workload monitoring module 202, and the efficiency evaluation module 203.

In step 303, workers' fitness scores are updated. The step 303 may be performed by the worker fitness evaluation module 204.

In step 304, a check is performed to determine if there are still tasks waiting to be allocated to workers. This check can be performed by the task allocation module 205.

In step 305, the task allocation plan, which consists of the number and types of tasks to be allocated to each of the selected workers, is determined. The task allocation plan may be based on the fitness scores such as, for example, if there are still more tasks waiting to be allocated to workers, the worker with the next highest fitness score in the worker fitness ranking list is selected. The calculation of workers' fitness scores may be performed by the worker fitness evaluation module 204. The step 305 may be performed by the task allocation module 205.

In step 306, tasks are allocated to the currently selected worker. As many tasks are allocated to the currently selected worker until either the worker's current workload is equal to the worker's target workload, or there is no more task left to be allocated. The step 306 may be performed by the task allocation module 205. The fitness score of the currently selected worker is updated in step 307, and the method then returns to step 304.

Although only a single embodiment of the invention has been described herein, it will be appreciated that many modifications and variations are covered are possible within the scope of the appended claims without departing from the spirit and intended scope thereof.

1. A computer system comprising:
a computer processor;
at least one electronic interface; and
a data storage device, the data storage device storing:
(a) for each of a plurality of workers, a respective profile describing (i) at least one worker quality value indicative of the quality of work performed by the worker, and (ii) a current workload value indicative of the current level of workload of the worker;
(b) program instructions operative by the computer processor, to cause the computer processor automatically:
(i) to receive, from the at least one electronic interface, data describing one or more human intelligence tasks which are to be performed;
(ii) to receive, from the at least one electronic interface, data for updating the profiles;
(iii) to use the profiles to select for each task a corresponding one of the workers to perform the task; and
(iv) to transmit, using the interface, for each task a message to the corresponding selected worker indicating that the worker is to perform the task;
wherein the selection takes into account both the at least one worker quality value and the current workload value for each worker, whereby the selection of the worker takes into account the quality of work performed by the workers and the current level of workload of the workers.

2. The computer system of claim 1 in which the program instructions are operative to cause the computer system to select said selected worker by:
(a) forming for each of the workers a respective fitness function; and
(b) selecting the worker having the highest value of the fitness function, the fitness function increasing with an increasing value of the at least one said worker quality value, and decreasing with an increasing value of the of the current workload value.

3. The computer system of claim 2 in which the program instructions are operative to cause the computer to form the respective fitness function for each worker by:
(I) calculating a desired workload for each worker, as an increasing function of at least one said worker quality value; and
(II) calculating the fitness function as an increasing function of the desired workload of the worker, and a decreasing function of the current workload value.

4. The computer system of claim 2 in which each task is associated with an importance parameter indicating the importance of the task, and the fitness function includes a term which reduces the fitness function of each worker by an amount which depends positively on the importance parameter and inversely on at least one said worker quality value.

5. A method, for performance by a computer system comprising a computer processor, at least one electronic interface, and a data storage device, for allocating each of one or more human intelligence tasks to a corresponding one of a plurality of workers,
the data storage device storing for each of a plurality of workers, a respective profile containing (i) at least one worker quality value indicative of the quality of work performed by the worker, and (ii) a current workload value indicative of the current level of workload of the worker;
and the method including the steps of automatically:
(a) receiving, from the at least one electronic interface, data describing one or more tasks which are to be performed;
(b) receiving, from the at least one electronic interface, data for updating the profiles;
(c) using the profiles to select for each task a corresponding one of the workers to perform the task; and
(d) transmitting, using the interface, for each task a message to the corresponding selected worker indicating that the worker is to perform the task;
wherein the selection employs both the at least one worker quality value and the current workload value for each worker, whereby the selection of the worker takes into account the quality of work performed by the workers and the current level of workload of the workers.

6. The method of claim 5 in which step (a) is performed by:
(i) forming for each of the workers a respective fitness function; and
(ii) selecting the worker having the highest value of the fitness function, the fitness function increasing with an increasing value of at least one said worker quality value, and decreasing with an increasing value of the of the current workload value.

7. The method of claim 6 in which the respective fitness function for each worker is formed by:
(I) calculating a desired workload for each worker, as an increasing function of at least one said worker quality value; and
(II) calculating the fitness function as an increasing function of the desired workload of the worker, and a decreasing function of the current workload value.

8. The method of claim 6 in which each task is associated with an importance parameter indicating the importance of the task, and the fitness function includes a term which reduces the fitness function of each worker by an amount which depends positively on the importance parameter and inversely on at least one said worker quality value.

9. A tangible data storage device storing non-transitory computer program instructions for performance by a computer system comprising a computer processor, at least one electronic interface; and a database storing for each of a plurality of workers, a respective profile describing (i) at least one worker quality value indicative of the quality of work performed by the worker, and (ii) a current workload value indicative of the current level of workload of the worker;
the program instructions being operative by the computer processor, to cause the computer processor automatically:
(a) to receive, from the at least one electronic interface, data describing one or more human intelligence tasks which are to be performed;
(b) to receive, from the at least one electronic interface, data for updating the profiles;
(c) to use the profiles to select for each task a corresponding one of the workers to perform the task; and
(d) to transmit, using the interface, for each task a message to the corresponding selected worker indicating that the worker is to perform the task;
wherein the selection employs both the at least one worker quality value and the current workload value for each worker, whereby the selection of the worker takes into account the quality of work performed by the workers and the current level of workload of the workers.
